(19) United States
(12) Patent Application Publication
(10) Pub. No.: US 2026/0194046 A1
(43) Pub. Date: Jul. 9, 2026

(54) A WIND TURBINE BLADE WITH AN IMPROVED LIGHTNING PROTECTING SYSTEM

(71) Applicant: LM Wind Power A/S, Kolding (DK)

(72) Inventors: Mahdi BAVILOLIAIE, Kolding (DK); Ian STEWART, Hampshire (GB); Lars Bo Hansen, Kolding (DK)

(21) Appl. No.: 18/868,203

(22) PCT Filed: May 16, 2023
(86) PCT No.: PCT/EP2023/063116

§ 371 Date: Nov. 22, 2024

(30) Foreign Application Priority Data
May 24, 2022 (EP) 22174996.3

(51) Int. Cl. F03D 80/30; F03D 1/06

(52) U.S. Cl. CPC F03D 80/301; F03D 1/0682; F05B 2280/2006; F05B 2280/6003

(57) ABSTRACT

A wind turbine blade lightning protection system has a lightning receptor arranged at an outer surface of the blade. Each of a first and a second carbon fibre reinforced spar cap has a chamfered tip end and an opposing chamfered root end. An electric connection between the lightning receptor and the chamfered tip end or the chamfered root end of the first or second spar cap includes a conductive fabric having unidirectional carbon fibres bonded by an adhesive, the conductive fabric comprising a thickness of 0.01-0.5 mm and a fibre volume fraction (FVF) of at least 50%.

### FIELD OF THE INVENTION

The present invention relates to a lightning protection system (LPS) for a wind turbine blade. In particular, the present invention relates to the use of a conducting fabric as part of an LPS system.

### BACKGROUND OF THE INVENTION

Wind power provides a clean and environmentally friendly source of energy. Wind turbines usually comprise a tower, generator, gearbox, nacelle, and one or more rotor blades. The wind turbine blades capture kinetic energy of wind using known airfoil principles. Modern wind turbines may have rotor blades that exceed 100 meters in length.

Wind turbine blades are usually manufactured by forming two shell parts or shell halves (i.e. a pressure side shell half and a suction side shell half) from layers of woven fabric or fibres and resin. Spar caps, which are also called main laminates, are placed or integrated in the shell halves and may be combined with shear webs or spar beams to form structural support for the blade. Spar caps or main laminates may be joined to, or integrated within, the inside of the suction and pressure halves of the shell. The shell halves of the wind turbine blade are typically manufactured as fibre composite structures by means of VARTM (vacuum assisted resin transfer moulding), where liquid polymer, also called resin, is filled into the blade mould cavity, in which a fibre lay-up has been inserted together with the spar cap and typically a sandwich core material, and where a vacuum is generated in the mould cavity, hereby drawing in the polymer. The polymer can be thermoset or thermoplastics. Typically, the mould cavity is covered with a resilient vacuum bag. By generating a vacuum, the liquid resin can be drawn in and fill the mould cavity with the fibre material contained herein. In most cases, the resin applied is polyester or epoxy, and typically the fibre lay-up is based on glass fibres and/or carbon fibres. Usually, a shear web is arranged in between the first spar cap and the second spar cap. Each shear web may comprise a web body, a first web foot flange at a first end of the web body, and a second web foot flange at a second end of the web body.

As wind turbines and wind turbine blades increase in size, the risk of a lightning strike hitting the wind turbine blades of the wind turbine increases. It is therefore of increasing interest to provide wind turbines and in particular wind turbine blades with lightning protecting measures. It is known to provide blades for wind turbines with lightning receptors, in electric connection with a down conductor that is able to connect a lightning current to ground. A lightning strike directly into the laminate may cause damage to a blade comprising electrically conductive fibres, as they would conduct the current and thereby would develop a substantial amount of heat.

Thus, it is of increasing importance to provide a lightning protection system (LPS) and ways of integrating a lightning protection system, which protects components of the wind turbine blade from being damaged by lightning strikes. This is even more important, if the wind turbine blade comprises conductive parts, such as carbon fibre reinforced spar caps. Typically, a lightning protection system comprises at least one lightning receptor located at or near the tip end of the blade that is electrically connected to the down conductor. The current is transferred from the lightning receptor or lightning receptors via cables to the down conductor and ground. However, when a lightning strikes a lightning receptor, there is a substantial risk of arcs (i.e. current jumping) into e.g. the spar caps due to the presence of conductive carbon fibres, which may cause damage to the blade. Thus, LPS systems typically also comprise means to equalize a voltage build-up between the spar caps and down conductor in order to avoid current jumping by establishing an electrical connection between the LPS system and the spar caps.

Spar caps are made from composite materials, often with carbon fabrics embedded in a cured resin matrix. While the carbon fibres in the fabric act as a conductive material the cured resin has insulating properties. The carbon fibres for spar caps are typically made from carbon rovings or tows, wherein the rovings or tows are either stitched and/or weaved together to form the fabric. Such fabrics may be in the form of precured elements, such as pultruded carbon planks.

An additional carbon fibre fabric can be used for providing the potential equalising connection between the carbon fibres of the spar caps, e.g. the pultruded carbon planks, and the LPS system. Stitching and/or weaving are not desirable in terms of conductivity for this additional carbon fabric, as it introduces some disturbance in the fabric and creates small pockets that may be filled with insulating resin, thus reducing the contact surface between the potential equalising carbon fabrics and the carbon fibres of the spar cap. The conductivity of the fabric is also reduced by introduction of unwanted non-conductive materials such as stitching yarn. Thus, it remains a challenge to obtain a proper electrical connection between the LPS system and the spar caps in order to equalize any voltage build-up arising during a lightning strike. In order to obtain an optimal electrical connection between the lightning receptors in the LPS system and the spar caps, the conductivity at the interface of the spar caps should be increased by increasing the contact area between the potential equalising carbon fabric and the spar cap, e.g. by increasing the number of conductive fibres (i.e. a high fibre volume fraction (FVF)). However, a high fibre volume fraction is hard to achieve using stitched and/or weaved fabrics, as the stitching process separates the carbon tows into bundles leaving room for formation of insulating resin rich pockets, when resin is infused to form the spar cap.

The present invention sets out to solve the problem of providing an improved electrical connection between the spar caps and the lightning receptors in an LPS system to equalize any voltage build-up leading to current jumping and eventually blade damage. It is therefore an object of the present invention to provide an LPS system having an improved electric connection between the lightning receptor and the spar cap. It is another object of the present invention to provide a lightning protection system for a wind turbine blade that reduces lightning strike damage to the blade, in particular to the spar cap.

### SUMMARY OF THE INVENTION

The present disclosure relates to an LPS system for a wind turbine blade comprising an improved electrical connection between the one or more lightning receptors and the spar cap(s) by use of high conductive fabrics.

Thus, in a first aspect the present disclosure relates to a lightning protection system for a wind turbine blade including a pressure side and a suction side, and a leading edge and a trailing edge with a chord having a chord length extending therebetween, the wind turbine blade extending in a spanwise direction between a root end and a tip end, the lightning protection system comprising
at least one lightning receptor arranged at an outer surface of the blade and a down conductor extending within the blade,
a first carbon fibre reinforced spar cap extending substantially in the spanwise direction of the wind turbine blade and having a chamfered tip end and an opposing chamfered root end, the first spar cap being arranged inside the blade along the pressure side,
a second carbon fibre reinforced spar cap extending substantially in the spanwise direction of the wind turbine blade and having a chamfered tip end and an opposing chamfered root end, the second spar cap being arranged inside the blade along the suction side,
wherein an electric connection between the at least one lightning receptor and the chamfered tip end and/or root end of the first and/or second spar cap comprises a conductive fabric, said conductive fabric comprising unidirectional carbon fibres bonded by an adhesive, wherein the fabric has a thickness of 0.05-0.3 mm and a fibre volume fraction (FVF) of at least 50%.

Similarly, the present disclosure relates to a wind turbine blade including a pressure side and a suction side, and a leading edge and a trailing edge with a chord having a chord length extending therebetween, the wind turbine blade extending in a spanwise direction between a root end and a tip end, wherein the wind turbine blade comprises:
a lightning protection system comprising at least one lightning receptor arranged at an outer surface of the blade and a down conductor extending within the blade,
a first carbon fibre reinforced spar cap extending substantially in the spanwise direction of the wind turbine blade and having a chamfered tip end and an opposing chamfered root end, the first spar cap being arranged inside the blade along the pressure side, and
a second carbon fibre reinforced spar cap extending substantially in the spanwise direction of the wind turbine blade and having a chamfered tip end and an opposing chamfered root end, the second spar cap being arranged inside the blade along the suction side,
wherein an electric connection between the at least one lightning receptor and the chamfered tip end and/or root end of the first and/or second spar cap comprises a conductive fabric, said conductive fabric comprising unidirectional carbon fibres bonded by an adhesive, wherein the fabric has a thickness of 0.05-0.3 mm and a fibre volume fraction (FVF) of at least 50%.

The present inventors found that the electrical connection between the spar caps and the LPS system could be improved by use of a thin layer of a conductive fabric configured at a chamfered tip end and/or root end of the first and/or second spar cap. The conductive fabric was found to greatly improve the conductivity at the interface of the spar cap by having a high fibre volume fraction (FVF) of at least 50%, preferably at least 55%, more preferably at least 60%, which allows the fabric to establish an improved electrical connection with the carbon fibres present in the spar cap. Typically, the FVF is in the range of 50-75%, preferably in the range of 60-70%. A conductive fabric with a fibre volume fraction (FVF) of at least 50% may be manufactured by gluing the fibres together by means of an adhesive thereby circumventing the need for stitching and/or weaving and minimizing the presence of insulating pockets in the fabric and further avoiding non-conductive stitching yarn. The inventors found that it was essential that the fabric did not exceed 0.3 mm in thickness, as a thicker fabric hampered the penetration of resin during resin infusion due to the high fibre volume fraction. It is accordingly also understood that the fabric is preferably provided without stitching and weaving. The resin is only supplied in a fraction that allows the fabric to be arranged as a single fabric during the manufacture of the wind turbine blade. Accordingly, it is also understood that the characteristics may refer to the carbon fabric, when applying the carbon fabric to the spar cap during manufacturing of the wind turbine blade. In other preferred embodiments, the FVF is at least 70%, preferably at least 75%, more preferably at least 80%, and even more preferably more than 85%, and even at least 90%. The fabric thickness of 0.05-0.3 mm is measured under vacuum (i.e. VARTM). Thus, at atmospheric pressure the thickness may be twice as much (i.e. 0.1-0.6 mm).

The conductive fabric may be arranged on various positions of the first and/or second spar cap. In a preferred embodiment, the conductive fabric is arranged on at least part of the chamfered tip end and/or root end of the first and/or second spar cap. In another preferred embodiment, the conductive fabric is arranged such that it substantially covers all of the chamfered tip end and/or root end of the first and/or second spar cap. The chamfered tip end and/or root end were found to be particular advantageous for establishing an electrical connection with the spar cap due to the more exposed carbon fibres present in these regions compared to the rest of the spar cap.

In a preferred embodiment, the LPS system for the wind turbine blade includes a plurality of lightning receptors to mitigate the risk of a lightning strike into the laminate. At least one of the pluralities of lightning receptors are positioned at or near the tip end of the blade. Preferably, 2-4 lightning receptors are present in the tip region of the blade where the risk of lightning strikes is highest. The tip end lightning receptor is preferably arranged at or in the immediate vicinity of the tip of the blade. The tip end lightning receptor may be located on the outer surface of the blade, or it may take the form of a solid metal tip conformal with the shape of the blade with the tip end region. The tip end lightning receptor may also be conformal with the shape of the tip end. In some embodiments, the tip end lightning receptor is implemented as a solid carbon fibre tip. In the present context, the tip end/region extends spanwise from the tip end of the blade and comprises up to 10% of the blade length. In another embodiment, the lightning receptor(s) in the tip of the blade is/are electrically connected to the down conductor and the spar caps, wherein the connection to the spar cap comprises a conductive fabric as described herein. Preferably, the lightning receptors in the tip end of the blade are only electrically connected to the down conductor.

In another embodiment, the down conductor comprises a cable made of or comprising an electrically conductive material, such as copper or aluminium, and extending within the shell body to the root end of the blade. The down conductor is preferably connected to ground via the rotor hub so that current from a lightning strike can be safely conducted from the tip end lightning receptor to the down conductor and finally to ground. However, in other embodiments, a spark gap is provided between the down conductor and the rotor hub. The down conductor may be electrically insulated at least up to the shell body of the blade and preferably at least partially through the shell body. Thus, the risk for damaging lightning strikes or flashovers is minimised even further. Albeit a lightning current is captured by a lightning receptor in the tip end of the blade and conducted to the down conductor and into the earth, the conductive fibres in the spar cap may cause the current to jump into the laminate and hence cause damage thereto.

Thus, in a highly preferred embodiment, a plurality of lightning receptors is configured to be exposed along either, or along both, of the pressure side or the suction side at or near the spar cap in addition to the lightning receptor(s) present in the tip end of the blade. Preferably, the lightning receptors at or near the spar cap are configured in the surface of the blade on either chordal side of the spar cap, e.g. in the surface of the blade in a region extending between the spar and the trailing edge of the blade. In another embodiment, the lightning receptor(s) at or near the spar cap is/are configured to be exposed at the surface of the blade in a region extending between the spar and the leading edge of the blade. The lightning receptor(s) at or near the spar cap extend through the blade skin and is/are electrically connected to the down conductor and the spar cap, and the potential equalising connection to the spar cap comprises the conductive fabric. Thus, at least one of the lightning receptors configured at or near the spar cap is electrically connected to the spar cap in addition to the down conductor in order to equalize any voltage build-up and minimize the risk of current jumping. Preferably, all of the lightning receptors configured at or near the spar cap are electrically connected to the spar cap in addition to the down conductor. In another embodiment, the conductive fabric may be used to establish an improved electrical connection between the spar cap and any of the lightning receptors including lightning receptors in the tip end of the blade. Preferably, the conductive fabric is used to improve the electrical connection between the lightning receptors located at or near the spar. The lightning receptor(s) at or near the spar cap may be any type of lightning receptor commonly used in LPS systems comprising a conductive material, such as carbon nanotubes or a metal. However, preferably the lightning receptor(s) is/are metallic bolt(s).

In a preferred embodiment, the conductive fabric is used to establish an electrical connection with the at least one lightning receptor present at or near the chamfered tip end and/or root end of the first and/or second spar cap. In some embodiments, a plurality of lightning receptors may be present at or near the chamfered tip end and/or root end of the first and/or second spar cap such as e.g. 2-10 receptors. In some embodiments, 1-5 receptors are present at or near the chamfered tip end of the first and/or second spar cap. In some embodiments, 1-5 receptors are present at or near the chamfered root end of the first and/or second spar cap. Preferably, lightning receptors are present at both the root end and tip end of the first and/or second spar cap. Preferably, each of the receptors present at or near the chamfered tip end and/or root end of the first and/or second spar cap are electrically connected to the spar cap using the conductive fabric or conductive fabrics. One or more conductive fabrics may be positioned on the chamfered tip end and/or root end of the first and/or second spar cap depending on the number of lightning receptors that are to be electrically connected with the spar cap.

Preferably, at least one lightning receptor is positioned at or near the chamfered tip end and/or root end of the first and/or second spar cap and is electrically connected to the first and/or second spar cap via the conductive fabric.

More preferably, at least one lightning receptor is positioned at or near the chamfered tip end and at least one lightning receptor is positioned at the chamfered root end of the first and/or second spar cap, wherein each of the at least one lightning receptors are electrically connected to the first and/or second spar cap via the conductive fabric.

More preferably, at least one lightning receptor is positioned at or near the chamfered tip end and at least one lightning receptor is positioned at the chamfered root end of the first and second spar cap, wherein each of the at least one lightning receptors are electrically connected to the first and/or second spar cap via the conductive fabric.

Preferably, 3-5 lightning receptors are configured at or near the chamfered tip end and 3-5 lightning receptors are configured at or near the opposing chamfered root end of the first spar cap. Likewise, preferably 3-5 lightning receptors are configured at or near the chamfered tip end and 3-5 lightning receptors are configured at or near the opposing chamfered root end of the second spar cap. Preferably, all of the lightning receptors are electrically connected to the respective first or second spar cap via the conductive fabric in order to minimize the risk of arcs (i.e. current jumping).

In any of the above embodiments preferably, the electric connection between the at least one lightning receptor and the chamfered tip end and/or root end of the first and/or second spar cap further comprises at least one metallic mesh, preferably a copper mesh. A metallic mesh may in some embodiments be configured beneath the lightning receptor, configured in the skin of the blade, and extend to the conductive fabric on the spar cap. This ensures a particular effective means for equalizing any difference in electric potential between the spar caps and down conductor.

Preferably, the conductive fabric is arranged in between at least part of the metallic mesh and at least part of the chamfered tip end and/or root end of the first and/or second spar cap. Preferably, the conductive fabric is in contact with at least part of a metallic mesh and at least part of the chamfered tip end and/or root end of the first and/or second spar cap. In a preferred embodiment, unidirectional carbon fibres in the conductive fabric are arranged in a spanwise direction between the chamfered tip end and root end of the first and/or second spar cap. This ensures that the carbon fibres are substantially aligned with the carbon fibres in the spar cap leading to an improved electrical connection.

In a particularly preferred embodiment, the first spar cap may further be electrically connected to the second spar cap by at least one conductor, preferably a metal conductor such as a cable comprising a metal conductor, as an equipotential connection between the first and the second spar cap. This can be achieved by having both spar caps electrically connected to the down-conductor. The equipotential connection can equipotentialize a voltage build-up between the first and the second spar cap.

In a preferred embodiment, the conductor between the first and second spar cap for the equipotential connection extends from the pressure side spar cap to the suction side spar cap, e.g. substantially in the flapwise direction of the wind turbine blade. In a preferred embodiment, said conductor is connected to the first and second spar cap with respective anchor blocks (outside the spar caps) and bolts, each bolt being received in a respective anchoring block. Thus, a first anchor block is preferably arranged at the inside facing surface of the blade shell, and a second anchor block is preferably arranged at the inside facing surface of an opposite side of the blade shell, wherein a first bolt extends from the opposing outside facing surface of the blade shell, being received, for example in a threaded connection in the first anchor block. Similarly, a second bolt may extend from the opposing outside facing surface of the blade shell, being received, for example in a threaded connection in the second anchor block. The first and second bolts may be electrically connected to the conductor for the equipotential connection.

In a second aspect, the disclosure relates to a non-woven and non-stitched conductive fabric for use in a lightning protection system, wherein the fabric comprises unidirectional carbon fibres bonded by an adhesive (or tackifier), wherein the fabric has a thickness of 0.05-0.3 mm and a fibre volume fraction (FVF) of at least 50%. Preferably the adhesive in the conductive fabric is thermoplastic adhesive, preferably a polyester, such as a bisphenolic polyester. An example of adhesive is the polyester marketed under the name NEOXIL 940 such as NEOXIL 940 PMX, NEOXIL 940 KS 1 and NEOXIL 940 HF 2B, all manufactured by DSM Composite Resins AG. Alternatively, the adhesive may be a hotmelt adhesive or based on a prepreg resin. The conductive fabrics may be manufactured from carbon large fibre tows of e.g. 12K, 24K or 50K using tow-spreading technology such as the FUKUI method, wherein large fibre tows are spread by application of air into smaller fibre bundles, whereafter the thermoplastic resin is applied as adhesive. The smaller fibre bundles are applied resin and passed through heating rollers and cooling rollers to obtain a thin sheet of conductive fabric without the need for weaving and/or stitching. These embodiments improve the contact area between the carbon fibres of the spar cap and the carbon fibres of the conductive fabric (for potential equalisation). Further, by avoiding stitching and weaving, the large contact area is maintained, because the risk of formation of insulating resin rich areas is minimised.

In a third aspect, the present disclosure relates to a method of manufacturing a shell half structure with an LPS system for a wind turbine blade, the wind turbine blade having a profiled contour including a pressure side and a suction side, and a leading edge and a trailing edge with a chord having a chord length extending therebetween, the wind turbine blade extending in a spanwise direction between a root end and a tip end, the method comprises:
arranging one or more first layers of fibre fabrics, on the surface of a mould to form a first shell half structure,
arranging one or more second layers of carbon fibres in a mould to form a spar cap having a chamfered tip end and an opposing chamfered root end,
arranging at least one conductive fabric, comprising unidirectional carbon fibres bonded by an adhesive, wherein the fabric has a thickness of 0.05-0.3 mm and a fibre volume fraction (FVF) of at least 50%, on at least part of the chamfered tip end and/or opposing chamfered root end of the spar cap,
arranging at least one metallic mesh on at least part of the conductive fabric, consolidating the one or more first layers of fibre fabrics, one or more second layers of carbon fibres, the conductive fabric and the metallic mesh.

The consolidating step may include infusion of the lay-up by a resin or a binding agent, preferably by VARTM. In a preferred embodiment, the unidirectional carbon fibres are arranged in a spanwise direction between the chamfered tip end and root end of the first and/or second spar cap in order to substantially align the fibres in the conductive fabric with the fibres in the first and/or second spar cap. Preferably, the carbon fibres in the mould used to form the spar cap are carbon pultruded carbon planks.

As used herein, the term “tip end lightning receptor” means a lightning receptor which is arranged within the tip end region of the blade, the tip end region extending spanwise from the tip end of the blade and comprising up to 10% of the blade length.

As used herein, the term “spanwise” is used to describe the orientation of a measurement or element along the blade from its root end to its tip end. In some embodiments, spanwise is the direction along the longitudinal axis and longitudinal extent of the wind turbine blade.

### DESCRIPTION OF THE INVENTION

The invention is explained in detail below with reference to an embodiment shown in the drawings, in which

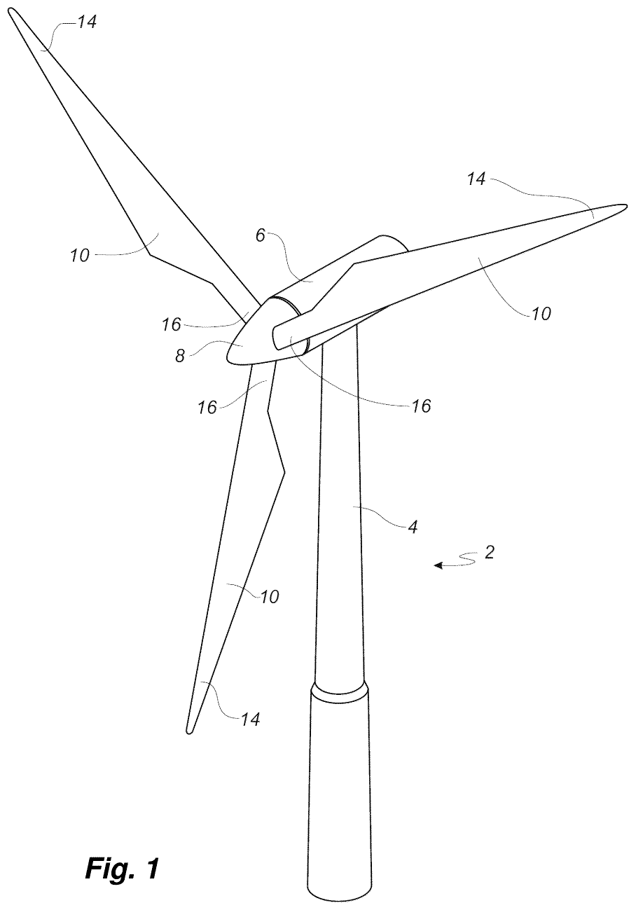

FIG. 1 shows a wind turbine,

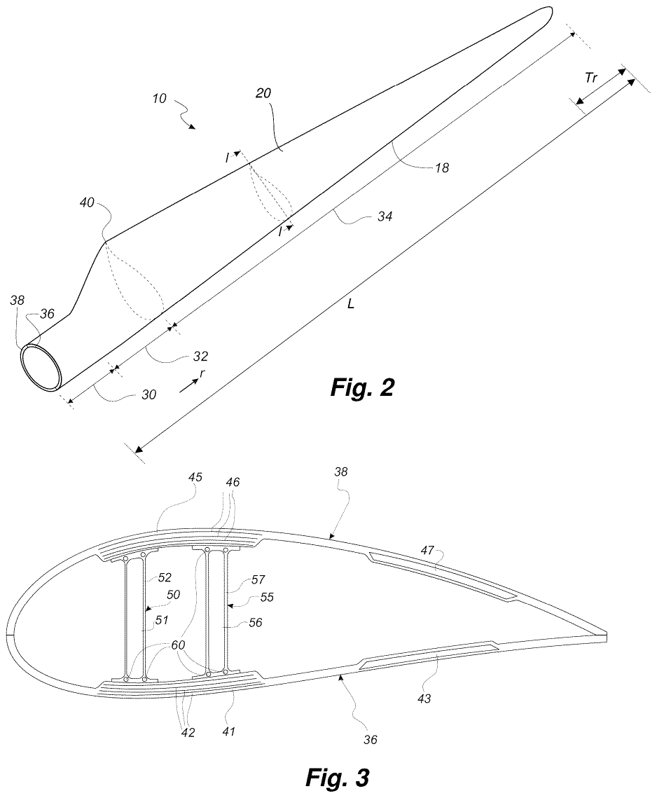

FIG. 2 shows a schematic view of a wind turbine blade,

FIG. 3 shows a schematic view of a cross-section of a wind turbine blade,

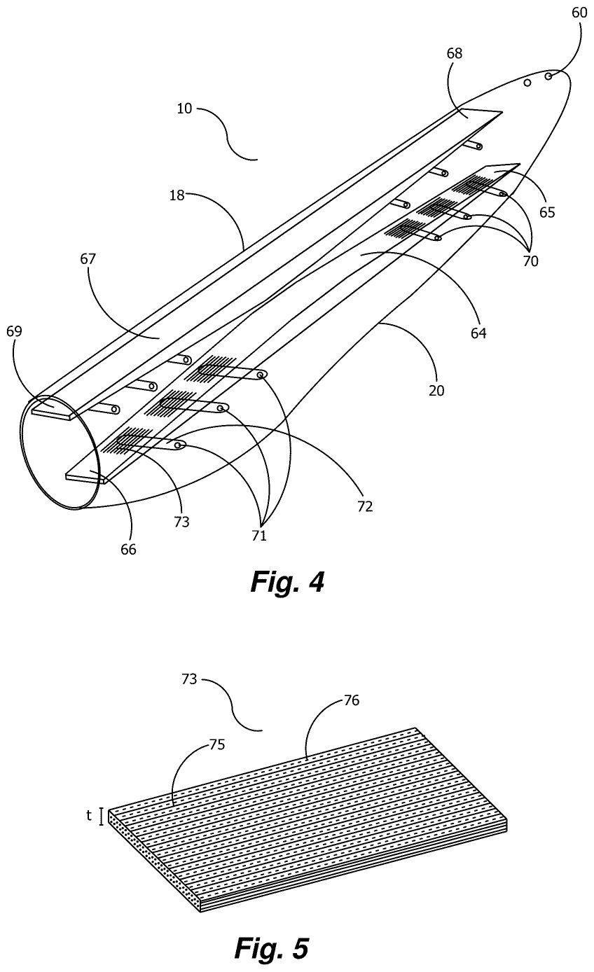

FIG. 4 shows a schematic perspective view of a wind turbine blade according to the present invention,

FIG. 5 shows a schematic view of a conductive fabric according to the invention.

### DETAILED DESCRIPTION OF THE FIGURES

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34. FIG. 2 also illustrates the longitudinal extent L, length or longitudinal axis of the blade, and the tip end region of the blade, the tip end region Tr extending spanwise from the tip end of the blade and comprising 10% of the blade length.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge of the blade 20.

FIG. 3 shows a schematic view of a cross section of the blade along the line I-I shown in FIG. 2. As previously mentioned, the blade 10 comprises a pressure side shell part 36 and a suction side shell part 38. The pressure side shell part 36 comprises a spar cap 41, also called a main laminate, which constitutes a load bearing part of the pressure side shell part 36. The spar cap 41 comprises a plurality of fibre layers 42 mainly comprising unidirectional fibres aligned along the longitudinal direction of the blade in order to provide stiffness to the blade. The suction side shell part 38 also comprises a spar cap 45 comprising a plurality of fibre layers 46. The pressure side shell part 36 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges. The shear web body comprises a sandwich core material 51, such as balsawood or foamed polymer, covered by a number of skin layers 52 made of a number of fibre layers. The blade shells 36, 38 may comprise further fibre-reinforcement at the leading edge and the trailing edge. Typically, the shell parts 36, 38 are bonded to each other via glue flanges.

In a preferred embodiment, the fibre layers 42, 46 are formed by pre-cured elements, such as carbon fibre pultrusion planks.

FIG. 4 shows a schematic view of a wind turbine blade 10 comprising an LPS system according to an embodiment of the invention. The wind turbine blade has a pressure side and a suction side, and a leading edge 18 and a trailing edge 20 with a chord having a chord length extending therebetween, the wind turbine blade extending in a spanwise direction between a root end and a tip end. The blade has a first carbon fibre reinforced spar cap 64 having a chamfered tip end 65 and an opposing chamfered root end 66, the first spar cap being arranged inside the blade along the pressure side. The blade has a second carbon fibre reinforced spar cap 67 having a chamfered tip end 68 and an opposing chamfered root end 69, the second spar cap being arranged inside the blade along the suction side. For simplicity, the wind turbine blade has been depicted without the shear webs that connect the first spar cap 64 and the second spar cap 67.

As mentioned above, the spar cap may be formed from pre-cured elements, such as carbon fibre pultrusion planks. The end faces of the pultrusion planks may be chamfered in order to provide the chamfered tip end 68 and the chamfered root end 69.

In the shown embodiment, the first carbon fibre reinforced spar cap 64 has three lightning receptors 70 configured at the outer surface of the blade near a chamfered tip end 65 and three lightning receptors 71 configured at the outer surface of the blade near an opposing chamfered root end 66. Likewise, the second carbon fibre reinforced spar cap 67 has three lightning receptors configured at the outer surface of the blade near a chamfered tip end 68 and three lightning receptors configured at the outer surface of the blade near an opposing chamfered root end 69. However, a different number of receptors are also contemplated. Each of the lightning receptors are electrically connected to the first or second spar cap respectively by a metallic mesh 72 and a conductive fabric 73. The conductive fabric comprises unidirectional carbon fibres bonded by an adhesive, wherein the fabric has a thickness of 0.05-0.3 mm and a fibre volume fraction (FVF) of at least 50%. The lightning receptors are configured at a trailing edge region near the chamfered tip end or root end of the first and/or second spar cap. The lighting receptors near the chamfered tip end and near the opposing chamfered root end of the first and second spar cap are further electrically connected to the down conductor (not shown). The blade 10 further comprises two lightning receptors 60 at the tip end of the blade, which are electrically connected to the down conductor (not shown).

Further, the spar caps 64 and 67 may also have a mutual potential equalisation. This may be achieved by an electrical connection, such as a cable, extending from one of the receptors on the pressure side to the down-conductor, and a corresponding electrical connection from one of the receptors on the suction side to the down-conductor.

FIG. 5 shows a schematic view of a conductive fabric 73 comprising parallel carbon fibres 75 held together by an adhesive/tackifier 76. The adhesive makes stitching and/or weaving redundant and hence improves the conductivity of the fabric, as no disturbances in the fabric are introduced by stitching and/or weaving. This effectively minimizes the amount of resin rich pockets and allows for a higher FVF which improves the conductivity of the fabric. The fabric has a thickness (t) of 0.05-0.3 mm. A maximum thickness of 0.3 mm was found to be essential to allow proper wetting of the carbon fibres during resin infusion due the dense structure of the fabric. The conductive fabrics may be manufactured from carbon large fibre tows of e.g. 12K, 24K or 50K using tow-spreading technology, such as the FUKUI method, wherein large fibre tows are spread by application of air into smaller fibre bundles, whereafter the thermoplastic resin is applied as adhesive. This allows for manufacture of thin fabrics having a thickness as low as 0.04 mm.

The fabric as shown in FIG. 5 improves the contact area between the carbon fibres of the spar cap and the carbon fibres of the conductive fabric (for potential equalisation). Further, by avoiding stitching and weaving, the large contact area is maintained, because the risk of formation of insulating resin rich areas is minimised. Thus, the functionality of the LPS system is improved over prior art systems.

The invention is not limited to the embodiments described herein and may be modified or adapted without departing from the scope of the present invention.

### LIST OF REFERENCE NUMERALS

4 tower
6 nacelle
8 hub
10 blades
14 blade tip
16 blade root
18 leading edge
20 trailing edge
30 root region
32 transition region
34 airfoil region
36 pressure side shell part
38 suction side shell part
40 shoulder
41 spar cap
42 fibre layers
43 sandwich core material
45 spar cap
46 fibre layers
47 sandwich core material
50 first shear web
51 sandwich core material
52 skin layers
55 second shear web
60 tip end lightning receptor
64 first carbon fibre reinforced spar cap
65 tip end of first spar cap
66 root end of first spar cap
67 second carbon fibre reinforced spar cap
68 tip end of second spar cap
69 root end of second spar cap
70 lightning receptor at chamfered tip end of first spar cap
71 lightning receptor at chamfered root end of first spar cap
72 metallic mesh
73 conductive fabric
75 carbon fibres
76 adhesive (i.e. tackifier)
t thickness
L length
r distance from hub
R rotor radius
Tr tip end region

### ITEMS

1. A lightning protection system for a wind turbine blade including a pressure side and a suction side, and a leading edge and a trailing edge with a chord having a chord length extending therebetween, the wind turbine blade extending in a spanwise direction between a root end and a tip end, the lightning protection system comprising
at least one lightning receptor arranged at an outer surface of the blade and a down conductor extending within the blade,
a first carbon fibre reinforced spar cap extending substantially in the spanwise direction of the wind turbine blade and having a chamfered tip end and an opposing chamfered root end, the first spar cap being arranged inside the blade along the pressure side,
a second carbon fibre reinforced spar cap extending substantially in the spanwise direction of the wind turbine blade and having a chamfered tip end and an opposing chamfered root end, the second spar cap being arranged inside the blade along the suction side,
wherein an electric connection between the at least one lightning receptor and the chamfered tip end and/or root end of the first and/or second spar cap comprises a conductive fabric, said conductive fabric comprising unidirectional carbon fibres bonded by an adhesive, wherein the fabric has a thickness of 0.01-0.5 mm and a fibre volume fraction (FVF) of at least 50%.
2. A lightning protection system according to item 1, wherein the thickness of the fabric is 0.025-0.4 mm, preferably 0.05-0.3 mm.
3. A lightning protection system according to item 1 or 2, wherein the fibre volume fraction of the conductive fabric is at least 55%, such as at least 60%, preferably at least 65%, more preferably at least 70%, yet more preferably at least 75%, even more preferably 80%, and preferably at least 85%, or at least 90%.
4. A lightning protection system according to any of items 1-3, wherein the conductive fabric is provided without any stitching material and without weaving.
5. A lightning protection system according to any of item 1-4, wherein the conductive fabric is formed from carbon fibre tows using a tow-spreading technology.
6. A lightning protection system according to item 5, wherein the carbon fibre tows have been formed by blowing air into the fibre tows to form smaller fibre bundles.
7. A lightning protection system according to item 5 or 6, wherein the adhesive is applied after the application of the tow-spreading technology.
8. A lightning protection system according to any of items 5-7, wherein the conductive fabric has further been formed by passing the fibre tows or smaller fibre bundles through rollers.
9. A lightning protection system according to any of the preceding items, wherein the electric connection between the at least one lightning receptor and the chamfered tip end and/or root end of the first and/or second spar cap further comprises a metallic mesh.
10. A lightning protection system according to any of the preceding items, wherein the conductive fabric is arranged in between at least part of the metallic mesh and at least part of the chamfered tip end and/or root end of the first and/or second spar cap.
11. A lightning protection system according to any of the preceding items, wherein the conductive fabric is in contact with at least part of a metallic mesh and at least part of the chamfered tip end and/or root end of the first and/or second spar cap.
12. A lightning protection system according to any of the preceding items, wherein the unidirectional carbon fibres in the conductive fabric are arranged in a spanwise direction between the chamfered tip end and root end of the first and/or second spar cap.
13. A lightning protection system according to any of the preceding items, wherein the first spar cap is electrically connected to the second spar cap by at least one conductor.
14. A lightning protection system according to any of the preceding items, wherein the conductor extends in a substantially flapwise direction.
15. A lightning protection system according to any of the preceding items, comprising a plurality of lightning receptors, wherein the plurality of lightning receptors is configured along either, or along both, of the pressure side or the suction side, each of the lightning receptors extending through one or more glass fibre layers.
16. A lightning protection system according to item 8, wherein the plurality of lightning receptors is configured at a trailing edge region at or near the chamfered tip end or root end of the first and/or second spar cap.
17. A lightning protection system according to any of the preceding items, wherein the lightning receptor(s) is/are metallic bolt(s).
18. A lightning protection system according to item 10, wherein a segmented lightning conductor is arranged on or in the outer blade surface, said segmented lightning conductor being electrically connected to one or more of the metallic bolts extending through said one or more glass fibre layers.
19. A non-woven and non-stitched conductive fabric for use in a lightning protection system according to items 1-11, comprising unidirectional carbon fibres bonded by an adhesive, wherein the fabric has a thickness of 0.01-0.5 mm and a fibre volume fraction (FVF) of at least 50%.
20. A non-woven and non-stitched conductive fabric according to item 19, wherein the adhesive comprises a polyester.
21. A non-woven and non-stitched conductive fabric according to item 19 or 20, wherein the thickness of the fabric is 0.025-0.4 mm, preferably 0.05-0.3 mm.
22. A non-woven and non-stitched conductive fabric according to any of items 19-21, wherein the fibre volume fraction of the conductive fabric is at least 65%, preferably at least 70%, more preferably at least 75%, even more preferably 80%, and preferably at least 85%, or at least 90%.
23. A non-woven and non-stitched conductive fabric according to any of items 19-22, wherein the conductive fabric is formed from carbon fibre tows using a tow-spreading technology.
24. A non-woven and non-stitched conductive fabric according to item 23, wherein the carbon fibre tows have been formed by blowing air into the fibre tows to form smaller fibre bundles.
25. A non-woven and non-stitched conductive fabric according to items 23 or 24, wherein the adhesive is applied after the application of the tow-spreading technology.
26. A non-woven and non-stitched conductive fabric according to any of items 23-25, wherein the conductive fabric has further been formed by passing the fibre tows or smaller fibre bundles through rollers.
27. A method of manufacturing a shell half structure with an LPS system for a wind turbine blade, the wind turbine blade having a profiled contour including a pressure side and a suction side, and a leading edge and a trailing edge with a chord having a chord length extending therebetween, the wind turbine blade extending in a spanwise direction between a root end and a tip end, the method comprises:
arranging one or more first layers of fibre fabrics, on the surface of a mould to form a first shell half structure,
arranging one or more second layers of carbon fibres in a mould to form a spar cap having a chamfered tip end and an opposing chamfered root end,
arranging at least one conductive fabric, comprising unidirectional carbon fibres bonded by an adhesive, wherein the carbon fabric has a thickness of 0.05-0.3 mm and a fibre volume fraction (FVF) of at least 50%, on at least part of the chamfered tip end and/or opposing chamfered root end of the spar cap,
arranging at least one metallic mesh on at least part of the conductive fabric, consolidating the one or more first layers of fibre fabrics, one or more second layers of carbon fibres, the conductive fabric and the metallic mesh.
28. A method according to item 27, wherein the unidirectional carbon fibres in the conductive fabric are arranged in a spanwise direction between the chamfered tip end and root end of the first and/or second spar cap.
29. A method according to item 27 or 28, wherein the spar cap comprises precured elements, such as pultruded carbon fibre planks, comprising the unidirectional carbon fibres.
30. A method according to any of items 27-29, wherein the metallic mesh is a copper mesh.
31. A use of a conductive fabric for potential equalising a carbon fibre reinforced spar cap of a wind turbine to a lightning protection system of the wind turbine, wherein the carbon fabric has a thickness of 0.05-0.3 mm and a fibre volume fraction (FVF) of at least 60%.

1-15: (canceled)

16. A wind turbine blade with a lightning protection system, comprising:
a pressure side and a suction side, and a leading edge and a trailing edge with a chord having a chord length extending between the leading and trailing edges;
a root end and a tip end, the wind turbine blade extending in a spanwise direction between the root end and the tip end;
the lightning protection system comprising:
at least one lightning receptor arranged at an outer surface of the blade;
a first carbon fibre reinforced spar cap extending substantially in the spanwise direction of the wind turbine blade and having a chamfered tip end and an opposing chamfered root end, the first spar cap arranged inside the blade along the pressure side;
a second carbon fibre reinforced spar cap extending substantially in the spanwise direction of the wind turbine blade and having a chamfered tip end and an opposing chamfered root end, the second spar cap arranged inside the blade along the suction side; and
an electric connection between the at least one lightning receptor and the chamfered tip end or the chamfered root end of one of the first carbon fibre reinforced spar cap or the second carbon fibre reinforced spar cap, the electric connection comprising a conductive fabric having unidirectional carbon fibres bonded by an adhesive, the conductive fabric comprising a thickness of 0.01-0.5 mm and a fibre volume fraction (FVF) of at least 50%.

17. The wind turbine blade according to claim 16, wherein the thickness of the conductive fabric is 0.025-0.4 mm.

18. The wind turbine blade according to claim 16, wherein the fibre volume fraction (FVF) of the conductive fabric is at least 55%.

19. The wind turbine blade according to claim 16, wherein the conductive fabric is a nonwoven material void of stitching material.

20. The wind turbine blade according to claim 16, wherein the electric connection further comprises a metallic mesh. between the lightning receptor and the conductive fabric.

21. The wind turbine according to claim 16, wherein the metallic mesh is configured between the lightning receptor and the conductive fabric.

22. The wind turbine according to claim 16, wherein the unidirectional carbon fibres in the conductive fabric are arranged in a spanwise direction between the chamfered tip end and chamfered root end of the first carbon fibre reinforced spar cap or the second carbon fibre reinforced spar cap.

23. A non-woven and non-stitched conductive fabric for use in a lightning protection system in a wind turbine blade, comprising unidirectional carbon fibres bonded by an adhesive, wherein the conductive fabric has a thickness of 0.01-0.5 mm and a fibre volume fraction (FVF) of at least 50%.

24. The non-woven and non-stitched conductive fabric according to claim 23, wherein the adhesive comprises a polyester.

25. The non-woven and non-stitched conductive fabric according to claim 23, wherein the thickness of the conductive fabric is 0.025-0.4 mm.

26. The non-woven and non-stitched conductive fabric according to claim 23, wherein the fibre volume fraction of the conductive fabric is at least 65%.

27. A method of manufacturing a shell half structure with a lightning protection system for a wind turbine blade having a pressure side and a suction side, and a leading edge and a trailing edge, the method comprising:
arranging one or more first layers of fibre fabrics on a surface of a mould to form a first shell half structure,
arranging one or more second layers of carbon fibres in a mould to form a spar cap having a chamfered tip end and an opposing chamfered root end,
arranging at least one conductive fabric on at least part of the chamfered tip end or opposing chamfered root end of the spar cap, the conductive fabric having unidirectional carbon fibres bonded by an adhesive, a thickness of 0.05-0.3 mm, and a fibre volume fraction (FVF) of at least 50%;
arranging a metallic mesh on at least part of the conductive fabric; and
consolidating the one or more first layers of fibre fabrics, one or more second layers of carbon fibres, the conductive fabric, and the metallic mesh.

28. The method according to claim 27, wherein the unidirectional carbon fibres in the conductive fabric are arranged in a spanwise direction between the chamfered tip end and the chamfered root end of the spar cap.

29. The method according to claim 27, wherein the spar cap includes pultruded carbon fibre planks containing the unidirectional carbon fibres.

30. A method for electrical potential equalizing a carbon fibre reinforced spar cap of a wind turbine blade, comprising using the conductive fabric according to claim 23 in a lightning protection system of the wind turbine blade.
